(19) United States
(12) Patent Application Publication
(10) Pub. No.: US 2023/0312152 A1
(43) Pub. Date: Oct. 5, 2023

(54) System To Facilitate Reconfiguration Of Containers

(71) Applicant: Goodpack IBC (Singapore) Pte. Ltd., Singapore (SG)

(72) Inventor: Uthai Srichai, Bangkok (TH)

(21) Appl. No.: 18/023,849

(22) PCT Filed: Sep. 14, 2021
(86) PCT No.: PCT/IB2021/000622

§ 371 Date: Feb. 28, 2023

Related U.S. Application Data
(60) Provisional application No. 63/078,596, filed on Sep. 15, 2020.

(51) Int. Cl. B65B 43/26; B65G 7/08

(52) U.S. Cl. CPC B65B 43/265; B65G 7/08; B65G 2201/0235

(57) ABSTRACT

Described herein are a system and method for reconfiguring collapsible containers. The system includes a conveyor for transporting a container having sidewalls in a collapsed arrangement to a rotation station. The system also includes at least one securement member for releasably securing the container such that the container is rotatable. The system further includes a drive for rotating the container from a first angular orientation to a second angular orientation such that the sidewalls fall from the collapsed arrangement to an erected arrangement.

### CROSS-REFERENCE TO RELATED APPLICATIONS

This application claims priority to U.S. Provisional Application No. 63/078,596, filed Sep. 15, 2020, which is hereby fully incorporated by reference as if fully set forth herein.

### FIELD

This application relates to a system to facilitate reconfiguration of shipping containers.

### BACKGROUND

Reusable, stackable containers such as those disclosed in U.S. Pat. No. RE 47,210, PCT/IB2020/000183 filed Apr. 17, 2020, and PCT/IB2020/000378 filed May 14, 2020, which are incorporated by reference herein, can be useful for transporting various types of cargo, e.g., by ship, by rail, by truck, in domestic or overseas commerce, and in other contexts. Certain containers include collapsible walls for facilitating storage and/or transportation of containers without payloads. Each side wall may be pivotable on the base of the container. Each side wall may be locked in an upright position during use of the container. After the container has been emptied, each of the side walls may be pivoted inward through an angle of about 90° so that the side walls are stacked on the base. When the container is to be reused, a collapsed container may be reconfigured to an erect position, i.e., the walls may be pivoted upward away from the base, then locked in upright positions, to restore the container to a working configuration. In some instances, reconfiguration of collapsed containers may be labor-intensive, difficult and/or time consuming.

### SUMMARY

Disclosed herein is a system to facilitate container reconfiguration. In some embodiments, the system includes a mechanism to pivot the container walls from generally collapsed or horizontal positions to generally upright or erect positions. In some embodiments, the system comprises a holder for temporarily supporting the container, and a drive mechanism for rotating the container to cause all of the sidewalls of the container to pivot from collapsed positions to erected positions. In some embodiments, the system includes a conveyor for transporting a container having sidewalls in a collapsed arrangement to a rotatable support or frame. The support may include at least one securement member for releasably securing the container to the rotatable support such that the container is rotatable. The system may further include a drive for rotating the support from a first angular orientation to a second angular orientation such that one or more sidewalls pivot under the influence of gravity from the collapsed arrangement toward an erected arrangement.

A method of assembling a container may include transporting a container having sidewalls in a collapsed arrangement to a rotatable support or holder. With the container at the rotatable holder, the method may include securing the container to the rotatable support such that the container is rotatable. The method may further include rotating the container from a first angular orientation to a second angular orientation such that the sidewalls fall from the collapsed arrangement to an erected arrangement.

### BRIEF DESCRIPTION OF THE DRAWINGS

FIG. 1 is a perspective view of a system for reconfiguring a container showing a collapsed container on a conveyor in a first station.

FIG. 2 is a perspective view of a collapsible container in a collapsed arrangement.

FIG. 3 is a perspective view of the collapsible container of FIG. 2 in an erected arrangement.

FIG. 4 is a perspective view of the system of FIG. 1 showing the collapsed container received at a rotatable support in a second station.

FIG. 5 is a perspective view of the system showing the rotation system and the collapsed container in a first angular orientation.

FIG. 6 is a perspective view of the system showing the rotatable holder and the container in a second angular orientation, with the sidewalls of the container having fallen from a collapsed arrangement to an erected arrangement.

FIG. 7 is a perspective view of the system showing the rotatable holder and the container in a third angular orientation, and an operator securing first adjacent sidewalls.

FIG. 8 is a perspective view of the system showing the operator securing second adjacent sidewalls.

FIG. 9 is a perspective view of the system showing the rotatable holder and the container in the first angular orientation with the container in an erected arrangement.

FIG. 10 is a perspective view of the system showing the erected container out of the rotatable holder, a second collapsible container in the rotatable holder, and a third collapsible container on the conveyor.

### DETAILED DESCRIPTION

Described herein is a system and method of reconfiguring a container. The system is configured to receive a container in a collapsed arrangement and secure the container such that it is fixed relative to a rotatable holder. The system is further configured to rotate the rotatable holder and container secured thereto such that the container is at least partially inverted. In the inverted position, sidewalls of the container fall due to gravitational forces. An operator may then lock the walls in the erected arrangement. The system may then return the container, now in the erected arrangement, to its original orientation. A conveyor may then transport the erected container out of the rotatable holder. The process may be repeated with additional collapsed containers. This automated or semi-automated process assembles a container more efficiently than manual reconfiguration, and reduces operator effort in reconfiguring a container.

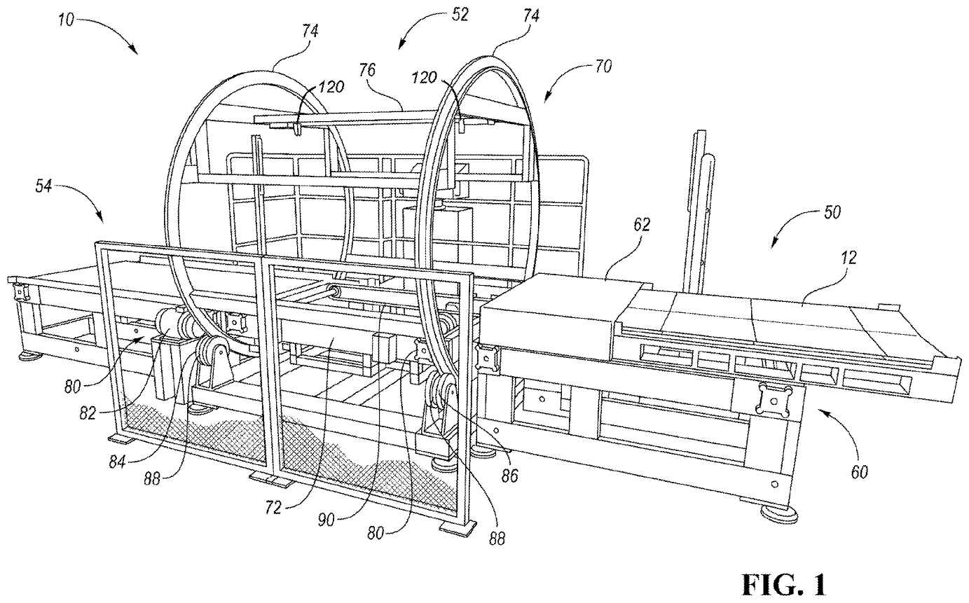

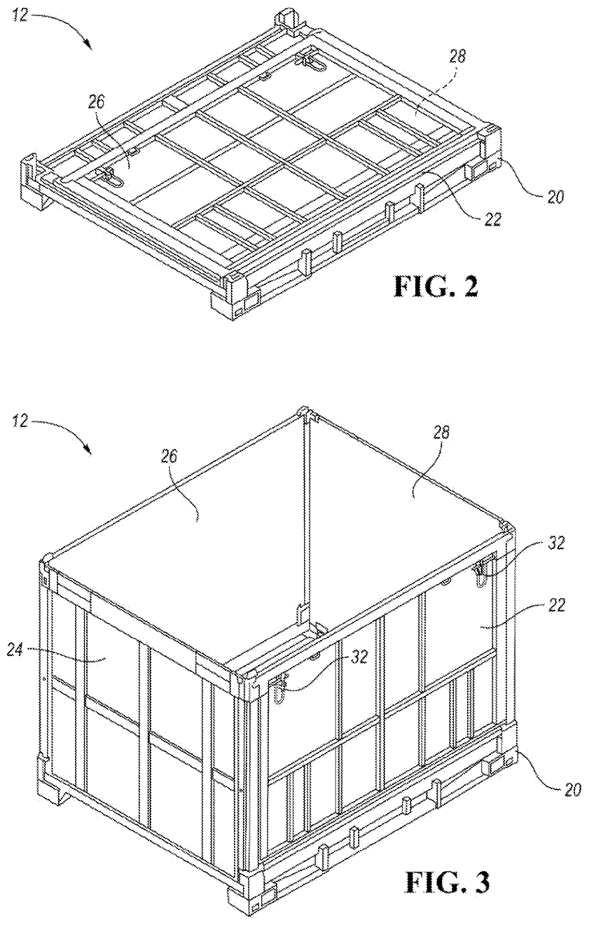

With reference to FIG. 1, a system 10 for reconfiguring a collapsible container 12 is shown. In some embodiments, and referring momentarily to FIGS. 2 and 3, the container 12 has a base 20 with four sidewalls 22, 24, 26, 28 secured to the base 20. The sidewalls 22, 24, 26, 28 may be rotated relative to the base 20 from a collapsed arrangement, shown in FIG. 2, to an erected arrangement, shown in FIG. 3. In the erected arrangement, a lid 30 may be supported on the upper edges of the sidewalls to enclose the interior of the container 12.

The container 12 includes locking mechanisms 32 adjacent opposite vertical edges of at least one of the sidewalls to facilitate securing and releasing adjacent sidewalls when the sidewalls are the erected arrangement.

Referring again to FIG. 1, the system 10 may include a plurality of stations, including a receiving station 50, a rotation station 52, and a removal station 54. The system 10 may include a first conveyor 60 for transporting the container 12 from the receiving station 50 to the rotation station 52. As the first conveyor 60 transports the container 12, the container 12 may pass below a bridge 62 of the receiving station 50. As discussed in greater detail below, the bridge 62 may support an operator 100 to allow the operator 100 to access the container 12 when the container 12 is in the rotation station 52.

The rotation station 52 may include a rotatable holder 70 that includes a base portion 72 and at least one rotatable frame 74 that is connected (directly or indirectly) to the base portion 72. The base portion 72 receives the container 12 from the first conveyor 60. In the example shown, the rotation holder 70 includes two circular rotatable frames 74 that are longitudinally offset from each other. The rotatable frames 72 have an inner dimension sufficient to receive the container 12 therebetween. For example, the rotatable frames 74 may have an inner diameter that is greater than an outer dimension of the container 12 such that the container 12 may pass through the two circular rotatable frames 74. One or more transverse brace members 76 may extend between the rotatable frames 74.

The rotatable frames 74 are connected to the base portion 72 such that the rotatable frames 74 and the base portion 72 are rotatable together. For example, when one or both of the rotatable frames 74 are rotated about a central axis, the base portion 72 is also rotated about the central axis.

The rotation holder 70 also includes at least one securement member 80 for releasably securing the container 12 to the rotation holder 70. For example, the securement member 80 may include at least one clamp for releasably securing the container 12 to the base portion 72.

In one approach, one or more (e.g., four) rotatable members are rotated into locking engagement with the base portion 72 of the container 12 such that rotation of the rotation holder 70 also rotates the container 12. The system 10 may include one or more electric motors that are configured to rotate the rotatable members between a disengaged position and an engaged position. In the engaged position, the base portion 72 of the container 12 is rotatably secured to the rotation holder 70. In another approach, one or more (e.g., four) pneumatic pumps are provided to secure the container 12 to the rotation holder 70 such that rotation of the rotation holder 70 also rotates the container 12.

The system includes a drive 82 for rotating the rotatable holder 70. The drive 82 may include a motor 84 that is operatively connected to a driven roller 86 such that operation of the motor 84 rotates the driven roller 86. The driven roller 86 may be engagement with the rotatable holder 70 such that rotation of the driven roller 86 effects rotation of the rotatable holder 70. In one example, the driven roller 86 includes a groove 88 that receives a portion of the rotatable frame 74 therein.

The rotation station 52 may also include one or more secondary rollers 86′ that have grooves 88′ similar to the grooves 88 of the driven roller 86. The secondary rollers 86′ may assist in supporting the weight, and facilitate rotation, of the rotatable holder 70 and container 12 received therein.

The rotation station 52 also includes a second conveyor 90 for receiving the container 12 from the receiving station 50 and for transporting the container 12 to the removal station 54

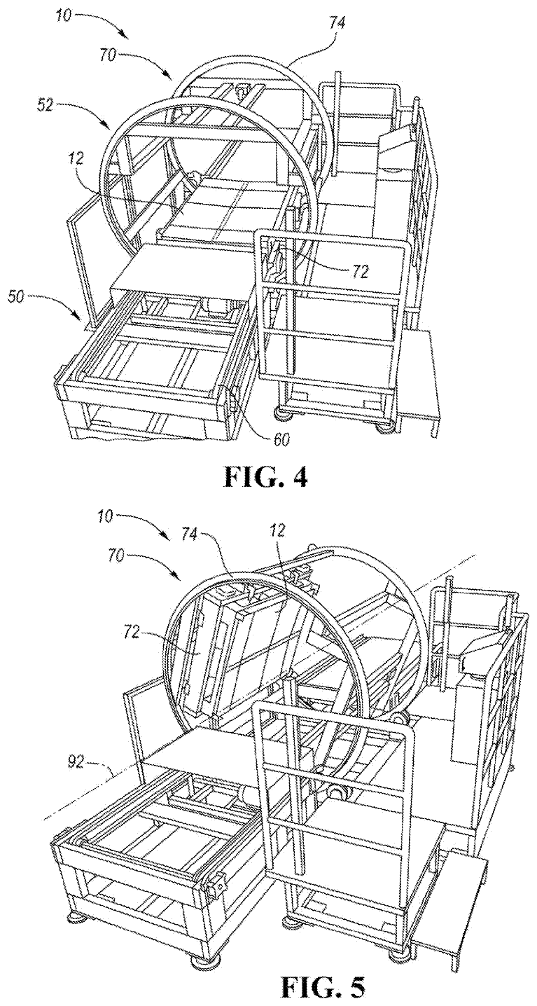

Referring now to FIGS. 4-10, a process of reconfiguring a container 12 is shown. The container 12 is transported by the conveyor 60 from the receiving station 50 to the rotation station 52, as shown in FIG. 4. During transport, the container 12 passes through a rotatable frame 74 until the container 12 is seated on the base portion 72. The container 12 is then secured to the base portion 72 (e.g., via the securement member 80 discussed with respect to FIG. 1).

As shown in FIG. 5, the rotatable holder 70, along with the container 12 and its sidewalls in the collapsed arrangement, are then rotated about an axis of rotation 92. More particularly, the motor 86 of the drive 82 of FIG. 1 causes the driven wheel 84 to rotate the rotatable frames 74 about the axis 92.

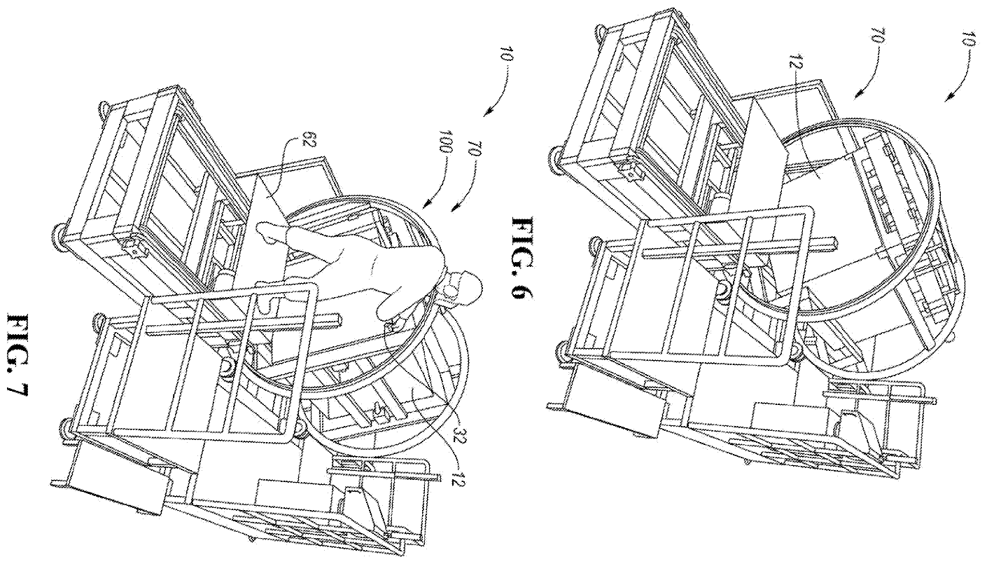

Referring to FIG. 6, the drive 82 rotates the rotatable holder 70 and container 12 such that the container 12 is inverted. The rotatable holder 70 and container 12 are rotated to an angular orientation sufficient to cause the sidewalls to fall from the collapsed arrangement to an erected arrangement. The inverted position may be in the range of approximately 135 degrees to approximately 180 degrees angularly offset from the original (e.g., horizontal) position of the container 12.

Referring to FIG. 7, the sidewalls of the container 12 may then be locked into place. In one example, an operator 100 may access the container 12 via the bridge 62. The operator 100 may then actuate one or more first locking mechanisms 32 to secure a first set of adjacent sidewalls of the container 12 in the erected arrangement.

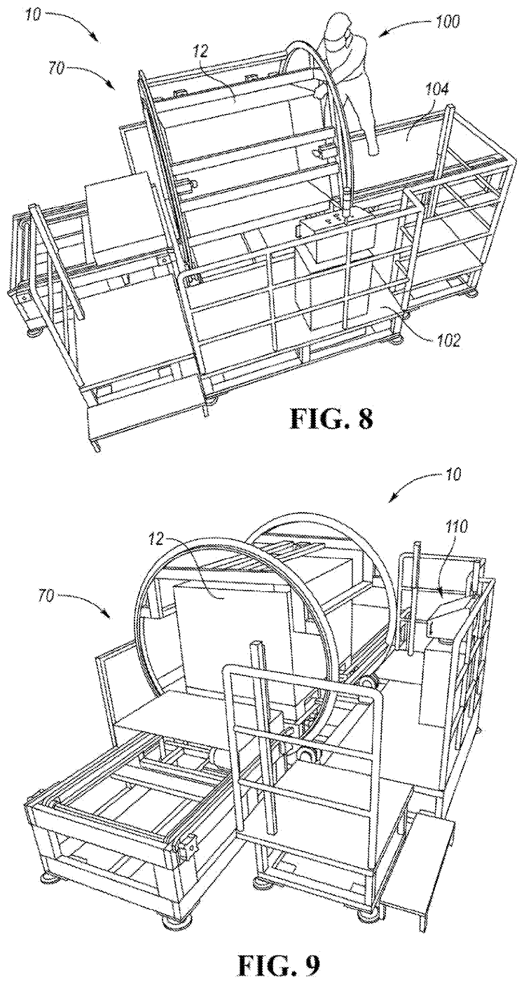

As shown in FIG. 8, the operator 100 may actuate one or more second locking mechanisms to secure a second set of adjacent sidewalls of the container 12 in the erected arrangement. More particularly, the operator 100 may traverse a first platform 102 to access a second platform 104 at the removal station 54.

In one approach, before the sidewalls are locked, the rotatable holder 70 and container 12 may be rotated in an opposite rotational direction to a third angular orientation that is between the first (horizontal) angular orientation and the second (inverted or partially inverted) angular orientation. For example, the rotatable holder 70 and container 12 may be rotated such that they are angularly offset from the first angular orientation in the range of approximately 100 degrees to approximately 170 degrees, and more particularly, approximately 110 degrees. This partial reverse rotation may assist an operator in locking the sidewalls by vertically raising the locking mechanisms relative to their previous position in the inverted orientation.

Referring to FIG. 9, after the sidewalls are secured in the erected arrangement, the rotatable holder 70 and the container 12 may be rotated back the first angular orientation. In one approach, the rotatable holder 70 and the container 12 are rotated back to the first angular orientation in response to receiving a user input. The user input may be received, for example, at a control station 110 of the system 10.

In another approach, when the container 12 is rotated to the inverted position (e.g., the position shown in FIG. 6 or a full 180 degree inverted position), one or more holding mechanisms 120 (also shown in FIG. 1) may be configured to hold one or more sidewalls (e.g., sidewalls 24 and 28) of the container 12 in the erected arrangement. In one example, a holding mechanism 120 may be or may include a movable member, such as a retractable mechanism or pin, that extends to hold a sidewall in an erected or nearly erected arrangement. The pin may be movable between a retracted position, in which the pin is not in the folding path of a sidewall, and an extended position, in which the pin is in the folding path of the sidewall such that the pin inhibits the sidewall from folding back from the erected arrangement to the collapsed arrangement.

The pins may permit the sidewalls to pivot slightly toward the collapsed arrangement. For example, the pins, when in the extended position, may be offset or spaced from a parallel axis of the sidewalls 24, 28. When the sidewalls 24, 28 are rotated back to the first angular orientation (e.g., the angular orientation shown in FIG. 9) the weight of the sidewalls 24, 28 may cause the sidewalls 24, 28 to pivot toward the collapsed arrangement. At least in part due to the spacing between the pins and the sidewalls 24, 28, the sidewalls 24, 28 may pivot in the range of approximately 1 degree to approximately 5 degrees, 10 degrees, or 15 degrees toward the collapsed arrangement before the sidewalls 24, 28 engage the pins. When the sidewalls 24, 28 engage the pins, the pins maintain the sidewalls 24, 28 in a nearly erected arrangement. With the container 12 rotated back to the first angular orientation and the sidewalls 24, 28 maintained in the nearly erected arrangement, the remaining sidewalls (e.g., sidewalls 22 and 26) are inhibited by sidewalls 24, 28 from folding back from the erected arrangement to the collapsed arrangement due to the edges of the sidewalls 24, 28 being in the folding path of the remaining sidewalls.

In this way, when the container 12 is rotated back to the first angular orientation, one or more of the sidewalls of the container 12 (e.g., sidewalls 22, 24, 26, and 28) are held or maintained in the erected or nearly erected arrangement. With the sidewalls maintained in the erected or nearly erected arrangement, an operator 100 may approach the container 10 to actuate one or more first and second locking mechanisms 32 to secure adjacent sidewalls of the container 12 in the erected arrangement. Thereafter, the holding mechanism 120 may be retracted and the securement member 80 may be disengaged from the base portion 72, thereby releasing the container 12.

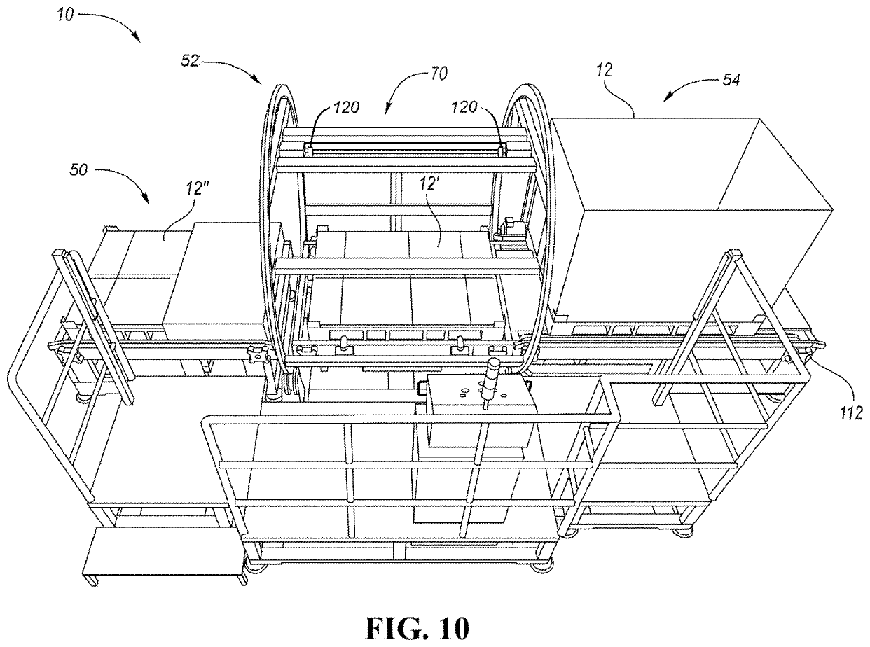

As shown in FIG. 10, the container 12 in the erected arrangement may then be moved to the removal station 54. For example, the second conveyor 90 of the rotation station 52 may cooperate with a third conveyor 112 of the removal station 54 to transport the container 12. A second container 12′ may then be transported from the receiving station 50 to the rotation station 52 in a manner similar to that discussed with respect to container 12. A third container 12″ may be provided at to the receiving station 50. In this way, a plurality of containers may be assembled by the system in an automated or semi-automated manner. Assembled containers 12 may then be removed from the removal station 54; for example, using a forklift or other suitable machine or device. In another approach, the system 10 may include, or be integrated with, a packaging line such that assembled containers 12 are directed from the system 10 to the packaging line.

The system 10 may utilize various approaches for rotating containers 12. For example, the rotatable holder 70 may include one or more rotatable frames 74 and may not include a base, or may include a base 72 and not a rotatable frame. Other structures and assemblies for rotating containers may be utilized.

The present disclosure describes embodiments and examples of cargo units and related methods of use and operation. Terms such as front, rear, side, vertical, horizontal, upper, lower, etc. are descriptive of the figures presented herein.

Those skilled in the art will recognize that a wide variety of modifications, alterations, and combinations can be made with respect to the embodiments described above without departing from the scope as set forth in the claims, and that such modifications, alterations, and combinations are to be viewed as being within the ambit of the inventive concept. In addition, it should also be understood that features of one embodiment described herein may be combined with features of other embodiments described herein.

1. A method of reconfiguring a container, the method comprising:
transporting a container having sidewalls in a collapsed arrangement to a rotatable holder;
securing the container in the collapsed arrangement to the rotatable holder such that the container is rotatable; and
rotating the container from a first angular orientation to a second angular orientation such that the sidewalls pivot from the collapsed arrangement to an erected arrangement due to the rotation.

2. The method of claim 1 wherein the container is transported along a conveyor to the rotatable holder.

3. The method of claim 1 wherein securing the container in the collapsed arrangement includes clamping a base portion of the container to secure the base portion relative to the rotatable holder.

4. The method of claim 1 wherein the second angular orientation is angularly offset from the first angular orientation in the range of approximately 135 degrees to approximately 180 degrees.

5. The method of claim 1 wherein the sidewalls fall from the collapsed arrangement to the erected arrangement at least in part due to a gravitational force acting on the sidewalls.

6. The method of claim 1 wherein the container includes at least four sidewalls that fall from the collapsed arrangement to the erected arrangement.

7. The method of claim 1, further comprising:
securing at least one sidewall to an adjacent sidewall to fix the at least one sidewall and the adjacent sidewall in the erected arrangement.

8. The method of claim 7 wherein securing the at least one sidewall to the adjacent sidewall includes actuating a lock on at least one of the sidewall and the adjacent sidewall.

9. The method of claim 1 further comprising:
actuating, when the container is in the second angular orientation, a movable member such that the movable member is in a folding path of at least one sidewall.

10. The method of claim 9 wherein the movable member includes an elongated retractable pin.

11. The method of claim 9 wherein the movable member is retractable from an extended first position and a retracted second position.

12. The method of claim 11 wherein the movable member is not within the folding path of the at least one sidewall in the extended first position, and wherein the movable member is within the folding path of the at least one sidewall in the retracted second position.

13. The method of claim 1 wherein the container is a first container, the method further comprising:
transporting the first container in the erected arrangement away from the rotatable holder;
transporting a second container having second sidewalls in a collapsed arrangement to the rotatable holder;
with the second container at the rotatable holder, securing the second container such that the second container is rotatable with the rotatable holder; and
rotating the second container such that the second sidewalls fall from the collapsed arrangement to an erected arrangement.

14. A system for reconfiguring a container from a collapsed configuration to an erected configuration, the system comprising:
a conveyor for transporting a container having sidewalls in a collapsed arrangement to a rotation station;
at least one securement member for releasably securing the container at the rotation station such that the container is rotatable; and
a drive for rotating the container from a first angular orientation to a second angular orientation such that the sidewalls fall from the collapsed arrangement to an erected arrangement.

15. The system of claim 14 wherein the rotation station includes a base portion for receiving the container from the conveyor, and wherein the securement member includes at least one clamp for releasably securing the container to the base portion.

16. The system of claim 14 wherein the rotation station includes at least one rotatable frame that receives the container within the rotatable frame.

17. The system of claim 16 wherein the drive includes a driven roller in engagement with a portion of the rotatable frame, and wherein rotation of the driven roller rotates the rotatable frame between the first angular orientation and the second angular orientation.

18. The system of claim 17 wherein the rotation station includes a first rotatable frame and a second rotatable frame longitudinally offset from the first rotatable frame, and wherein the drive includes a driven roller associated with the first rotatable frame and a secondary roller associated with the second rotatable frame.

19. The system of claim 14, further comprising:
a bridge for supporting an operator during reconfiguration of the container, the bridge extending over the conveyor for receiving the container prior to the container being received at the rotation station.

20. A system for reconfiguring a container from a collapsed configuration to an erected configuration, the system comprising a holder for temporarily supporting the container, and a drive mechanism for rotating the container to cause sidewalls of the container to pivot from collapsed positions to erected positions.
